(19) United States
(12) Patent Application Publication
(10) Pub. No.: US 2013/0335294 A1
(43) Pub. Date: Dec. 19, 2013

(54) ANTENNA DEVICE FOR ELECTROMAGNETIC MEASUREMENT

(71) Applicant: XIAO-LIAN HE, Shenzhen City (CN)

(72) Inventor: XIAO-LIAN HE, Shenzhen City (CN)

(73) Assignees: HON HAI PRECISION INDUSTRY CO., LTD., Tu-Cheng (TW); HONG FU JIN PRECISION INDUSTRY ( ShenZhen) CO., LTD., Shenzhen City (CN)

(21) Appl. No.: 13/551,206

(22) Filed: Jul. 17, 2012

(30) Foreign Application Priority Data
Jun. 14, 2012 (CN) 2012101959204

(51) Int. Cl. H01Q 1/12

(52) U.S. Cl. 343/880

(57) ABSTRACT

An antenna device includes a base, a first pole, a second pole, a supporting apparatus, and an antenna. A first slide apparatus is slidably fitted about the first pole. A second slide apparatus is slidably fitted about the second pole. The supporting pole includes a supporting pole, a first connecting block rotataly connected to the first slide apparatus, and a second connecting block slidably fitted about the supporting pole and rotatably connected to the second slide apparatus. Two motors respectively drive the first and second slide apparatus to move along the lengthwise direction of the first and second poles to adjust the height and the obliquity of the supporting pole. A cylinder with a telescopic rod is installed in the first connecting block, to horizontally adjust the antenna.

### CROSS-REFERENCE OF RELATED APPLICATIONS

Relevant subject matter is disclosed in two pending U.S. patent applications, both titled “ANTENNA DEVICE FOR ELECTROMAGNETIC MEASUREMENT”, respectively with the application Ser. No. 13/491,582, filed on Jun. 7, 2012, and 13/525,387, filed on Jun. 18, 2012, which are assigned to the same assignee as this patent application.

### BACKGROUND

1. Technical Field

The present disclosure relates to an antenna device for electromagnetic measurement.

2. Description of Related Art

In electromagnetic measurement, such as electromagnetic interference measurement, a test antenna is rotatably installed to a supporting pole for measuring an information technology equipments (ITEs), such as personal computers, liquid crystal displays, or mobile phones. The test antenna needs to align with the ITE during the test antenna sliding along the supporting pole, and the horizontal distance between the directional test antenna and the ITE is changed. However, the test antenna needs to be moved relative to the ITE, to allow the horizontal distance meets the measurement specification, which is time-consuming and inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of an antenna device.

FIG. 2 is similar to FIG. 1, but viewed from another perspective.

FIG. 3 is an exploded, partially cutaway view of FIG. 1.

FIG. 4 is a side plan view of FIG. 1, showing the antenna device in use.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

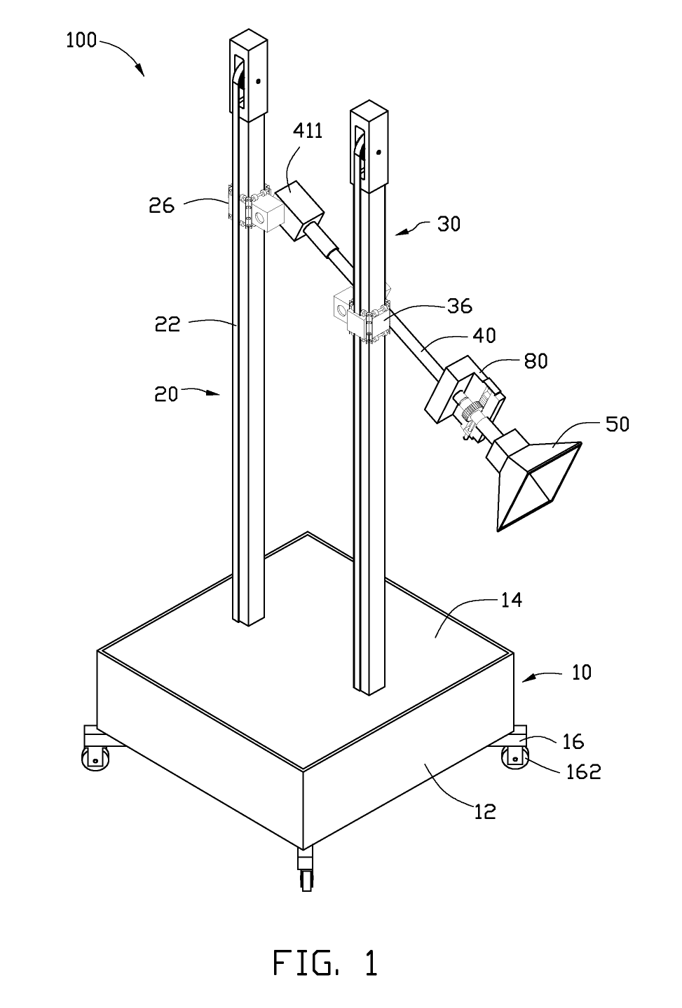

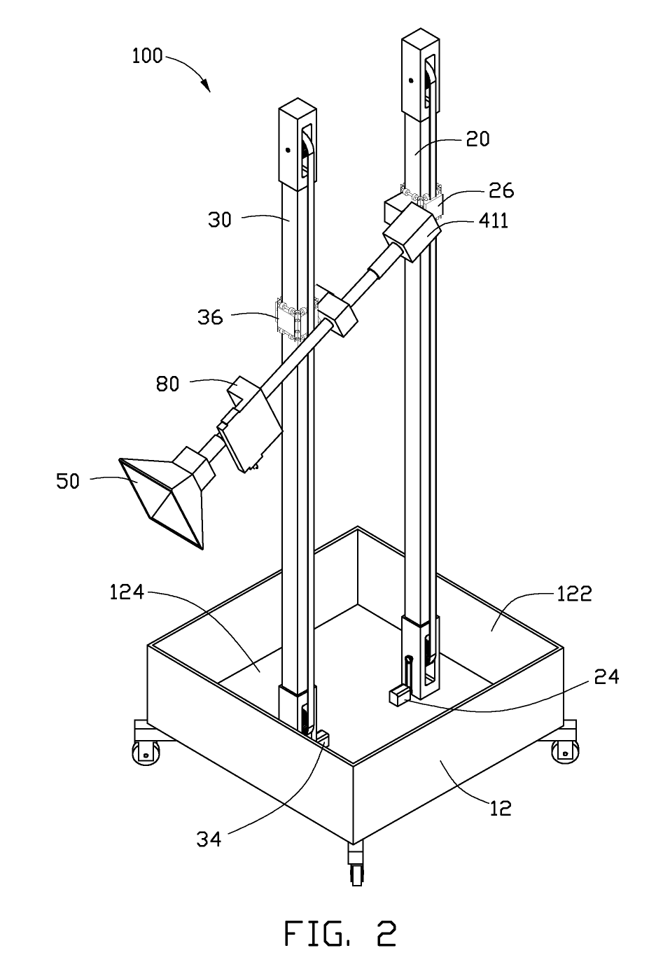

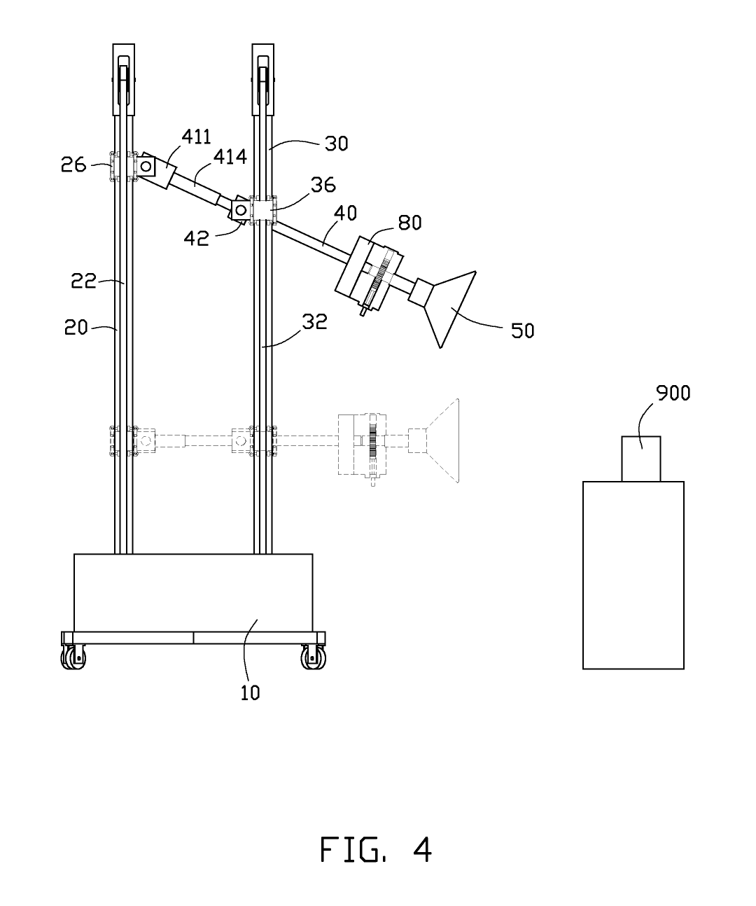

FIGS. 1 and 2, show an exemplary embodiment of an antenna device 100, which can be used to measure the intensity of electromagnetic radiations generated by an information technology equipment (ITE) 900 (shown in FIG. 4), such as a personal computer, a liquid crystal display, or a mobile telephone. The antenna device 100 includes a base 10, a first adjusting apparatus 20, a second adjusting apparatus 30, a supporting apparatus 40, an antenna 50 installed to a first end of the supporting apparatus 40, and a rotation apparatus 80. The structure of the first adjusting apparatus 20 is similar to the structure of the second adjusting apparatus 30.

The base 10 includes a rectangular shell 12, a cover 14, and a holder 16, mounted on the underside of the shell 12. The holder 16 is substantially cross-shaped and includes four conveying pulleys 162 respectively mounted on the undersides of the holder 16. Thus the holder 16 and the base 10 can be horizontally moved due to rotation of the conveying pulleys 162. The shell 12 defines a receiving space 122. The cover 14 is covered on the shell 12 for shielding the receiving space 122.

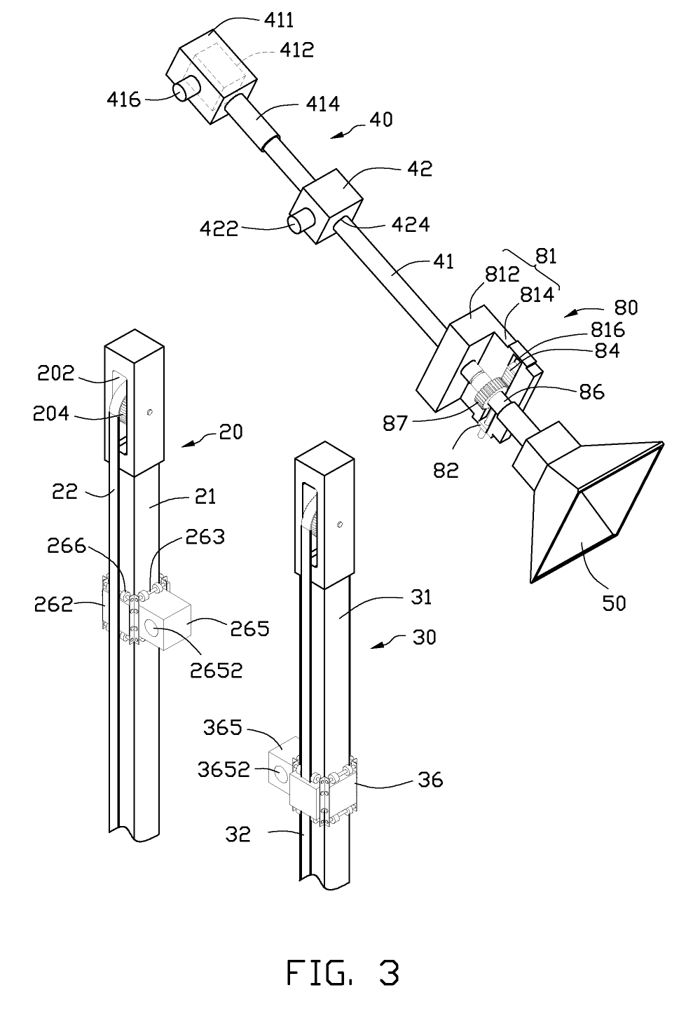

FIG. 3, the first adjusting apparatus 20 includes a pole 21, a transmission belt 22, a first slide apparatus 26, and a first motor 24. A bottom end of the pole 21 is perpendicularly mounted on a bottom plate of the shell 12 and extends through the cover 14. Two longitudinal through holes 202 are respectively defined in top and bottom ends of the pole 21. Each through hole 202 extends through opposite sides of the pole 21. An adjusting pulley 204 is rotatably mounted in each through hole 202. The transmission belt 22 is coiled between the adjusting pulleys 204 and is pulled to extend longitudinally along the pole 21 by the first motor 24 installed on the bottom plate of the shell 12. A rotation of the adjusting pulleys 204 can drive the transmission belt 22 to move along a lengthwise direction of the pole 21.

The first slide apparatus 26 includes four connecting plates 262 connected end to end to form a rectangular frame slidably fitted about the pole 21. Each of a top and a bottom of each connecting plate 262 is installed with a shaft 263. Two rollers 266 are rotatably fitted about each shaft 263 and are rotated along the pole 21. A positioning block 265 protrudes out from one of the connecting plate 262, and a part of the transmission belt 22 is fixedly extended through another connecting plate 262 neighboring the positioning block 265. In this way, movements of the transmission belt 22 along the pole 21 can drive the first slide apparatus 26 to slide along the pole 21. The positioning block 265 defines a shaft hole 2652 along the horizontal direction.

The second adjusting apparatus 30 includes a pole 31 parallel to the pole 21, a transmission belt 32, a second motor 34 driving the transmission belt 32, and a second slide apparatus 36. The second slide apparatus 36 is slidably fitted about the pole 31. The second slide apparatus 36 includes a positioning block 365 defining a shaft hole 2652 along the horizontal direction.

The supporting apparatus 40 includes a supporting pole 41 with the antenna 50 mounted to a first end of the supporting pole 41, a first connecting block 411 installed to a second end of the supporting pole 41 opposite to the antenna 50, and a second connecting block 42 fitted about the supporting pole 41, between the first connecting block 411 and the rotation apparatus 80. A cylinder 412 with a telescopic rod 414 is installed in the first connecting block 411, and an end of the telescopic rod 414 away from the cylinder 412 is mounted to the second end of the supporting pole 41. A shaft 416 protrudes out from the first connecting block 411, to be rotatably received in the shaft hole 2652 of the first slide apparatus 26. The second connecting block 42 defines a through hole 424 for slidably receiving the supporting pole 41. A shaft 422 protrudes out from the second connecting block 42, to be rotatably received in the shaft hole 3652 of the second slide apparatus 36.

The rotation apparatus 80 includes a substantially L-shaped installation bracket 81 installed to the first end of the supporting pole 41, a cylinder 82, a rack 84 slidable through the cylinder 82, and a rotation pole 86. The installation bracket 81 includes a rectangular first plate 812 fixed to the supporting pole 41, and a second plate 814 perpendicularly extending from a side of the first plate 812 toward the antenna 50. The second plate 814 defines a slot 816 parallel to the first plate 812, for receiving the rack 84 and the cylinder 82. A gear pulley 87 is installed to the rotation pole 86, to mesh with the rack 84. A first end of the rotation pole 86 axially defines a shaft hole (not shown) for rotatably receiving the first end of the supporting pole 41. The antenna 50 is installed to a second end of the rotation pole 86 opposite to the rotation apparatus 80. The gear pulley 87 is firmly fitted about a middle of the rotation pole 86.

FIG. 4, in use, the first motor 24 drives the first slide apparatus 26 to move along the lengthwise direction of the pole 21. The second motor 34 drives the second slide apparatus 36 to move along the lengthwise direction of the pole 31. The supporting pole 41 is adjusted to the height and the obliquity of the supporting pole 41, to allow the antenna 50 to align with the ITE 900. The cylinder 412 of the first connecting block 411 drives the telescopic rod 414 to stretch or withdraw to move the supporting pole 41 along the through hole 424 of the second connecting block 42, to adjust the horizontal distance between the antenna 50 and the ITE 900. The cylinder 82 drives the rack 84 to move along the slot 816 to allow the antenna 50 to rotate.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An antenna device, comprising:
a base;
a first adjusting apparatus comprising a first pole perpendicularly extending up from the base, a first slide apparatus slidably fitted about the first pole, and a first motor installed in the base connecting the first slide apparatus;
a second adjusting apparatus comprising a second pole perpendicularly extending up from the base and parallel to the first pole, a second slide apparatus slidably fitted about the second pole, and a second motor installed in the base connecting the second slide apparatus;
a supporting apparatus comprising a supporting pole, a first connecting block mounted to a first end of the supporting pole and roatabaly attached to the first slide apparatus, and a second connecting block slidably mounted to the supporting pole along a lengthwise direction of the supporting pole and rotatably attached to the second slide apparatus; and
an antenna installed to a second end of the supporting pole opposite to the supporting apparatus.

2. The antenna device of claim 1, wherein a first cylinder comprises a telescopic rod is installed in the first connecting block, the telescopic rod is fixed to the first end of the supporting pole, the first cylinder drives the telescopic rod to stretch or withdraw.

3. The antenna device of claim 1, wherein the second connecting block defines a through hole through which the second end of the supporting pole slidably extends.

4. The antenna device of claim 1, wherein the first adjusting apparatus further comprises a transmission belt, each of top and bottom ends of the first pole defines a longitudinal through hole, an adjusting pulley is rotatably mounted in each through hole, the transmission belt is coiled on the adjusting pulleys, the first motor is configured to drive the transmission.

5. The antenna device of claim 4, wherein the first slide apparatus comprises four connecting plates connected end to end to form a frame slidably fitted about the first pole, a part of the transmission belt is fixedly extended through one of the connecting plates.

6. The antenna device of claim 5, wherein two shafts are installed on each of a top and a bottom of each connecting plate, two rollers are rotatably fitted about each shaft.

7. The antenna device of claim 5, wherein a positioning block protrudes out from another connecting plate of the first slide apparatus, the positioning block defines a shaft hole, a shaft protrudes out from the first connecting block.

8. The antenna device of claim 1, wherein the second adjusting apparatus further comprises a transmission belt, each of top and bottom ends of the second pole defines a longitudinal through hole, an adjusting pulley is rotatably mounted in each through hole, the transmission belt is coiled on the adjusting pulleys, the second motor is configured to drive the transmission belt.

9. The antenna device of claim 8, wherein the second slide apparatus comprises four connecting plates connected end to end to form a frame slidbly fitted about the second pole, a part of the transmission belt is fixedly extended through one of the connecting plates.

10. The antenna device of claim 9, wherein two shafts are installed on each of a top and a bottom of each connecting plate, two rollers are rotatably fitted about each shaft.

11. The antenna device of claim 9, wherein a positioning block protrudes out from another connecting plate of the second slide apparatus, the positioning block defines a shaft hole, a shaft protrudes out from the second connecting block to be rotatably received in the shaft hole.

12. The antenna device of claim 1, further comprising a rotation apparatus, wherein the rotation apparatus comprises an installation bracket mounted to the second end of the supporting pole, a second cylinder, a rack slidably installed in the installation bracket through the second cylinder along a direction perpendicular to the lengthwise direction of the supporting pole, and a rotation pole, a first end of the rotation pole is rotatably connected to the supporting pole, the antenna is mounted to a second end of the rotation pole, a gear pulley is fitted about the rotation pole to mesh with the rack.
